(19) United States
(12) Patent Application Publication
(10) Pub. No.: US 2013/0098941 A1
(43) Pub. Date: Apr. 25, 2013

(54) PROPRIETARY DISPENSING CONTAINER SYSTEM

(71) Applicant: GOJO INDUSTRIES, INC., Akron, OH (US)

(72) Inventor: JACKSON W. WEGELIN, Stow, OH (US)

(73) Assignee: GOJO INDUSTRIES, INC., Akron, OH (US)

(21) Appl. No.: 13/654,862

(22) Filed: Oct. 18, 2012

Related U.S. Application Data
(60) Provisional application No. 61/551,017, filed on Oct. 25, 2011.

(51) Int. Cl. B67D 7/06

(52) U.S. Cl. 222/23

(57) ABSTRACT

A proprietary dispensing container system provides a base configured for use with compatible dispensing containers having a dispensing nozzle that when actuated dispenses liquid material, such as soap, therefrom. The dispensing containers include concentric alignment ribs configured to be received within corresponding concentric base channels disposed in a support platform to prevent unauthorized dispensers from being inserted therein. The dispensing containers also include indicators that are placed in an arrangement to identify attribute data relating to the dispensing containers and their contents, which is read by sensors in the support platform for presentation on a display. The support platform is suspended from the base by springs and moves as the dispensing nozzle is actuated to dispense material therefrom. A switch monitors the movement of the support platform and updates a count value that identifies the number of uses of the dispensing containers, which is presented on the display.

### CROSS-REFERENCE TO RELATED APPLICATION

This application claims the benefit of U.S. Provisional Application No. 61/551,017 filed Oct. 25, 2011, the contents of which are incorporated herein by reference.

### FIELD OF THE INVENTION

The present invention is generally related to dispensing systems. In particular, the present invention is directed to a proprietary dispensing system that provides a base that enables the use of only authorized dispensing containers. More specifically, the present invention is directed to a proprietary dispensing container system that provides a base that displays dispensing container attribute data and tracks the usage of authorized dispensing containers.

### BACKGROUND OF THE INVENTION

Permanently mounted dispensers, such as soap dispensers, used at restaurants, factories, hospitals, bathrooms, and the like, include a manual-actuation mechanism where the user physically pushes or pulls a lever to dispense a quantity of liquid material. Alternatively, permanently mounted “hands-free” automatic dispensers are also utilized where the user simply places his or her hands underneath a sensor, and a quantity of fluid is dispensed. Furthermore, while such permanently mounted dispensers hold a replenishible quantity of liquid material, such dispensers generally require specialized knowledge in order to refill them with additional material, and as such, are difficult and time consuming to service and maintain. As a result, disposable portable dispensing containers that utilize a hand-actuated pump and nozzle mechanism to dispense liquid material therefrom have become increasingly popular due to their ability to be easily placed in areas where they are needed, as well as their low cost, ease of replacement, and virtual mess-free operation.

Furthermore, manufacturers of permanently mounted dispensers have found it desirable to control the type of refill containers that are permitted or otherwise authorized to be used with particular permanently mounted dispensers. For example, it may be imperative for hospital personnel to have antibacterial soap dispensed in a pre-surgical cleaning area, rather than another material such as, moisturizing lotion for example. As such, manufacturers of permanently mounted dispensers often key the dispensers for use with only specific refill containers, such that only authorized refill containers can be installed and used in compatible dispensers. Permanently mounted dispenser manufacturers and associated refill container distributors also rely upon such keying systems to ensure that the dispensers can be refilled only with the refill containers that they supply, and not refill containers supplied by competitors or third parties that may be inferior or of poor quality.

Unfortunately, an effective system to control the use of portable and/or disposable dispensing containers, such as those having a hand actuated pump and dispensing nozzle, is not available. As such, portable and/or disposable dispensing containers may be misused, allowing a particular material to be improperly dispensed at a given location, which is unwanted.

Therefore, there is a need for a proprietary dispensing container system that provides a base that prevents the unauthorized use of portable dispensing containers. In addition, there is a need for a proprietary dispensing container system that provides a base that allows for the easy installation of a portable dispensing container. Furthermore, there is a need for a proprietary dispensing container system that allows consumed portable dispensing containers to be easily replaced. Additionally, there is a need for a proprietary dispensing container system that provides a base that monitors the usage of portable dispensing containers. Still yet, there is a need for a proprietary dispensing container system that provides a base that is able to identify various characteristics or attributes associated with the portable dispensing container, as well as the material contained therein, such as quantity of material, type of material, and the date of manufacture of the portable dispensing container, for example. In addition, there is a need for a proprietary dispensing container system that provides a base that displays various information associated with the attributes of the portable dispensing container, the material carried therein, and its usage.

### SUMMARY OF THE INVENTION

In light of the foregoing, it is a first aspect of the present invention to provide a proprietary dispensing system comprising a dispensing container having a dispensing nozzle that when actuated dispenses material therefrom; a base for carrying said dispensing container; a support platform carried by said base, said support platform includes a sensing surface that is configured to detect the arrangement of one or more indicators carried by said dispensing container when said dispensing container is placed on said support platform; a display carried by said base; and a controller coupled to said display and to said sensing surface, said controller storing dispensing container attribute data that is associated with one or more indicator profiles each defined by a predetermined arrangement of one or more said indicators; wherein said display presents said stored dispensing container attribute data associated with said indicator profile that matches the arrangement of said one or more indicators detected by said sensing surface carried by said dispensing container.

It is another aspect of the present invention to provide a proprietary dispensing system comprising a dispensing container having a dispensing nozzle that when actuated dispenses material therefrom, said dispensing container having a base surface with a receiving aperture having one or more indicators disposed therein and arranged in a predetermined pattern; a base for carrying said dispensing container, said base having a key arm carried by said base, said key arm configured to be received within said receiving aperture, so as to slideably retain said dispensing container to said key arm, said key arm including a sensing surface configured to detect the arrangement of said one or more indicators carried by said dispensing container; a support platform pivotably carried by said base and having a key aperture through which said key arm passes, said support platform resiliently biased upwardly from said base; a controller coupled to said sensor, said controller storing dispensing container attribute data that is associated with one or more indicator profiles each defined by a predetermined arrangement of one or more said indicators; and a display coupled to said controller; wherein when said receiving aperture of said dispensing container receives said key arm, said base surface of said dispensing container is carried by said support platform, and said display presents said stored dispensing container attribute data associated with said indicator profile that matches the arrangement of said one or more indicators of said dispensing container detected by said sensing surface.

Yet another aspect of the present invention is to provide a proprietary dispensing system comprising a dispensing container having an attachment aperture, said dispensing container having a tube with an inlet to receive liquid material carried by said dispensing container, said tube in fluid communication with said dome pump and a dispensing nozzle, wherein a one-way valve is disposed between said inlet and said dome pump; a base for carrying said dispensing container, said base having a having a resting section to normally support said base on a surface, said base including a pivot section extending at one end of said resting section upwardly, away from the surface, so as to form a pivot edge; a wall extending from said pivot section, said wall having a pivot aperture therethough; a protrusion extending from said base, said protrusion configured to selectively actuate said dome pump; an actuation assembly carried by said pivot aperture, said actuation assembly configured to pivot relative to said base, said actuation assembly configured to be lockingly received within said attachment aperture of said dispensing container; a controller carried by said base, said controller storing a count value; a switch coupled to said controller, said switch carried by said base so as to be in operative alignment with said dispensing container; and a display coupled to said controller; wherein when said dispensing container is pivoted by said actuation assembly so that said dome pump is actuated by said protrusion to dispense material from said dispensing nozzle, said switch is actuated to update said count value, which is presented on said display.

Still another aspect of the present invention is to provide a proprietary dispensing system comprising a dispensing container having a dispensing nozzle that when actuated dispenses material therefrom, said dispensing container having a base surface, that includes a stop tab and an engagement arm, said engagement arm having one or more control tabs extending therefrom; a base having a support platform moveably carried by said base, said support platform having a guide slot, and one or more stop slots disposed therethrough, said guide slot configured to receive said engagement arm therethrough, and wherein one of said one or more stop slots are configured to receive said stop tab therein; at least one potentiometer carried by said base and each said potentiometer configured to be rotated by said control tab; a controller coupled to each said at least one potentiometer, said controller storing dispensing container attribute data that is associated with one or more reference profiles that are defined by the amount of rotation of each said at least one potentiometer; and a display coupled to said controller; wherein when said dispensing container is carried upon said support platform and rotated until said stop tab is stopped by the end one of said one or more stop slots, said one or more control tabs rotate said at least one potentiometer by a predetermined amount, wherein said display presents said stored dispensing container attribute data associated with said reference profile that matches the amount of rotation of each said at least one potentiometer.

### BRIEF DESCRIPTION OF THE DRAWINGS

For a full understanding of the invention reference should be made to the following detailed description, appended claims, and the accompanying drawings, wherein:

FIG. 1 is a perspective view of a proprietary dispensing container system having a dispensing container removably attached to a base in accordance with the concepts of the present invention;

FIG. 2 is a perspective view of the dispensing container system with the dispensing container removed from the base in accordance with the concepts of the present invention;

FIG. 3 is an exploded view of the base of the proprietary dispensing container system in accordance with the concepts of the present invention;

FIG. 4 is a cross-sectional view of the base attached to the dispensing container of the proprietary dispensing container system in accordance with the concepts of the present invention;

FIG. 5A is a cross-sectional view of the base showing a spring biased support platform provided by the proprietary dispensing container system in its normal resting position in accordance with the concepts of the present invention;

FIG. 5B is a cross-sectional view of the base showing the spring biased support platform provided by the proprietary dispensing container system in an actuated position when the dispensing container is actuated in accordance with the concepts of the present invention;

FIG. 6 is a perspective view of an alternative proprietary dispensing container system with a dispensing container removed from a base in accordance with the concepts of the present invention;

FIG. 7 is a perspective view of the alternative proprietary dispensing container system with the dispensing container attached to the base in accordance with the concepts of the present invention;

FIG. 8 is a perspective view of the bottom of the base of the alternative proprietary dispensing container system in accordance with the concepts of the present invention;

FIG. 9 is a perspective view of the bottom of the dispensing container in accordance with the concepts of the present invention;

FIG. 10 is a top plan view of the base of the alternative proprietary dispensing container system in accordance with the concepts of the present invention;

FIG. 11 is a cross-sectional view of the alternative proprietary dispensing container system in which the dispensing container is being removed therefrom in accordance with the concepts of the present invention;

FIG. 12 is a cross-sectional view of the alternative proprietary dispensing container system in which the dispensing container is attached to the base in accordance with the concepts of the present invention;

FIG. 13 is an exploded view of another embodiment of the proprietary dispensing container system in accordance with the concepts of the present invention;

FIG. 14 is a cross-sectional side view of the proprietary dispensing container system in which the dispensing container is attached to a base in accordance with the concept of the present invention;

FIG. 15 is an exploded view of an actuation assembly utilized by the proprietary dispensing container system in accordance with the concepts of the present invention;

FIG. 16 is a perspective view of the actuation assembly utilized by the proprietary dispensing container system in accordance with the concepts of the present invention;

FIG. 17 is a perspective view of the dispensing container configured for use with the base of the proprietary dispensing container system in accordance with the concepts of the present invention;

FIG. 18 is a perspective view of the dispensing container attached to the base of the proprietary dispensing container system in accordance with the concepts of the present invention;

FIG. 19 is a perspective view of the dispensing container being rotated in the base to dispense material therefrom in accordance with the concepts of the present invention;

FIG. 20 is a cross-sectional view of an alternative base and attached dispensing container in which the actuation assembly is integral therewith in accordance with the concepts of the present invention;

FIG. 21 is an exploded view of the alternative base shown in FIG. 20 provided by the proprietary dispensing container system in which the actuation assembly is integral therewith in accordance with the concepts of the present invention;

FIG. 22 is a cross-sectional view of another embodiment of the proprietary dispensing container system with a dispensing container removed from a base in accordance with the concepts of the present invention;

FIG. 23 is a cross-sectional view of the proprietary dispensing container system with the dispensing container attached to the base in accordance with the concepts of the present invention;

FIG. 24 is a perspective view of the dispensing container in accordance with the concepts of the present invention;

FIG. 25 is an exploded view of the base configured for use with the dispensing container in accordance with the concepts of the present invention;

FIG. 26 is an elevational view of the bottom of the base in accordance with the concepts of the present invention;

FIG. 27 is a cross-sectional view of the dispensing container attached to the base in accordance with the concepts of the present invention; and

FIG. 28 is a cross-sectional view of the dispensing container attached to the base when the nozzle of the dispensing container is depressed in accordance with the concepts of the present invention.

### DETAILED DESCRIPTION

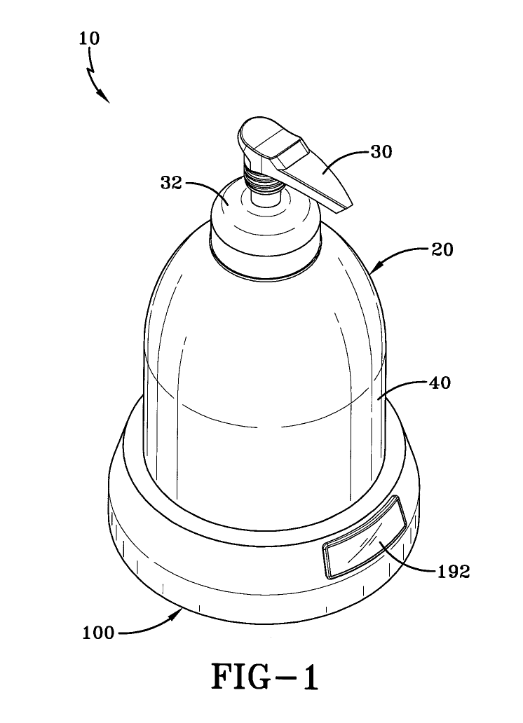

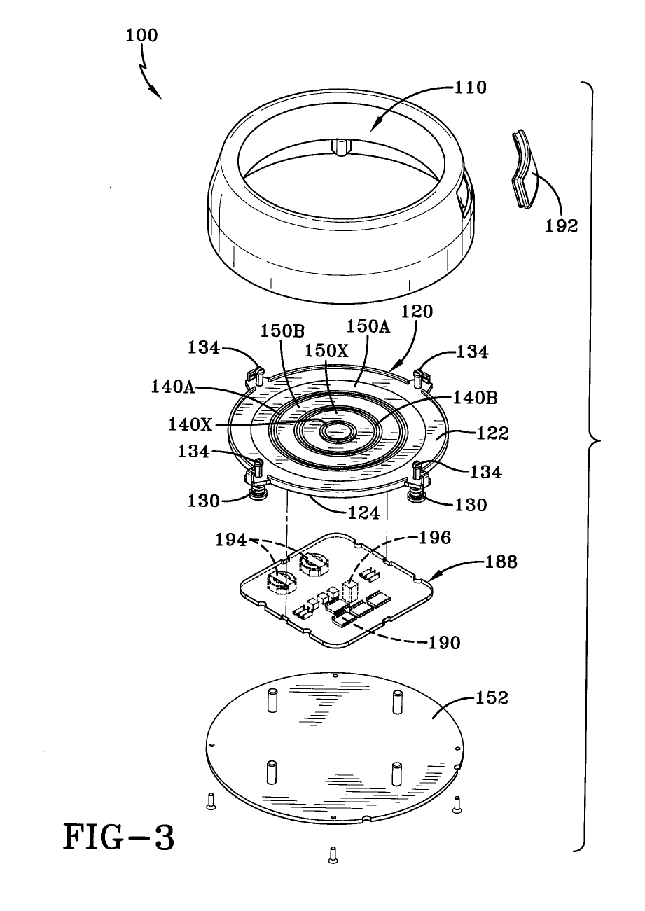

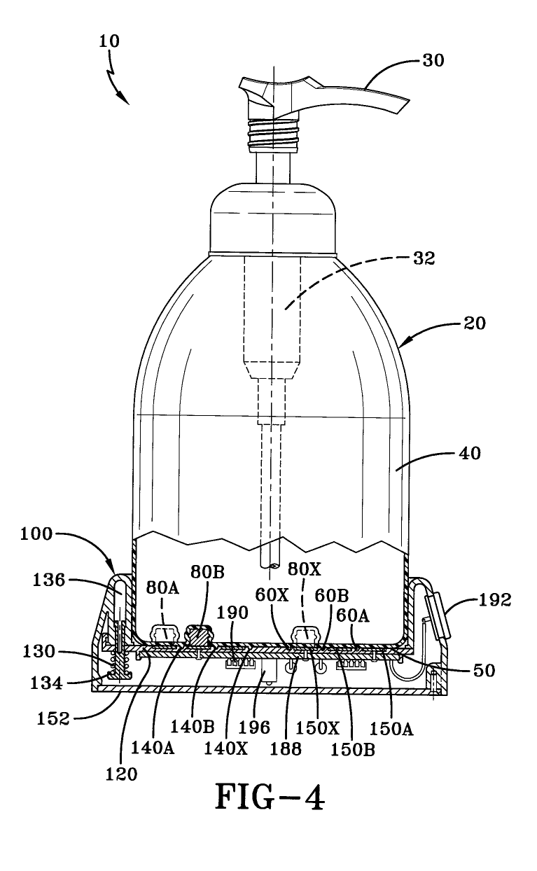

A proprietary dispensing container system is generally referred to by the numeral 10, as shown in FIGS. 1-5 of the drawings. The proprietary dispensing container system 10 includes a portable dispensing container 20 that is configured to dispense any suitable material, such as liquid soap, sanitizer, moisturizer, and the like. The dispensing container 20 also includes a dispensing nozzle 30 and pump 32, which is in fluid communication with a vessel 40 that carries the material to be dispensed. As such, when the pump 32 is actuated by the depression of the dispensing nozzle 30 by a user's hand, the liquid material carried in the vessel 40 is dispensed therefrom.

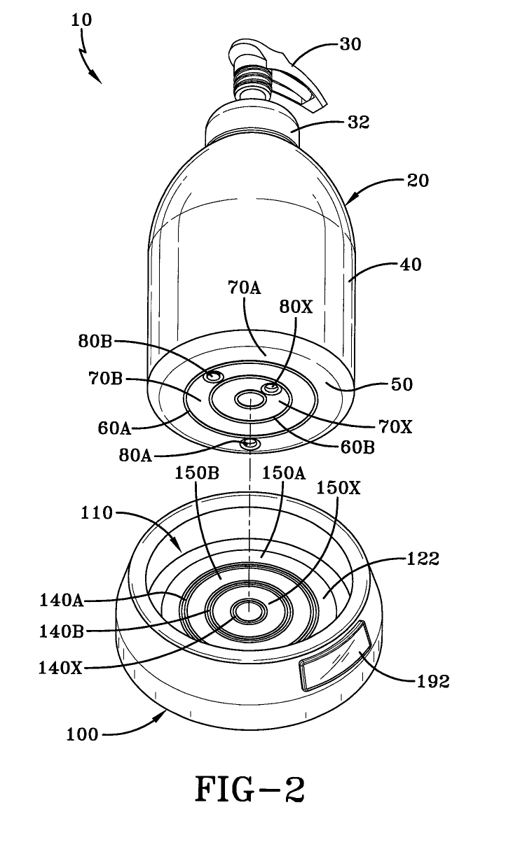

The vessel 40 of the dispensing container 20 includes a base surface 50 that includes a plurality of annular, concentric alignment ribs 60A-X that extend at a substantially right angle from the base surface 50 of the dispensing container 20, as shown in FIG. 2. Also disposed on the base surface 50 of the dispensing container 20 and concentrically arranged with the alignment ribs 60A-X are concentric indicator channels 70A-X. The indicator channels 70A-X are disposed adjacent to the alignment ribs 60A-X in an alternating manner, and include one or more indicators 80A-X disposed thereon. The indicators 80A-X may comprise any suitable magnet, capacitively detectable marker, or other electronically detectable marker or token for example. Although the indicators 80A-X are shown as being arranged in the concentric indicator channels 70A-X, it is also contemplated that the indicator channels 70A-X and the indicators 80A-X disposed therein may be oriented or arranged in any desired configuration. Specifically, the position or orientation of the indicators 80A-X that is provided on the dispensing container 20 define various attribute data associated with the dispensing container 20 and the material carried therein, such as the type of material, the quantity of material, date of manufacture, and the like. For example, one or more indicators 80A-X may be arranged to indicate that the dispensing container 20 contains soap; arranged to indicate that the dispensing container 20 contains moisturizer; or arranged to indicate that the dispensing container 20 contains sanitizer.

The dispensing container 20 is configured to be placed on a base 100 having a receiving cavity 110 that is bounded partially by a support platform 120, as shown in FIG. 2. The support platform 120 has inner and outer surfaces 122,124 and is suspended from the base 100 by springs 130 that are retained by pins 134 that are attached to retaining apertures 136 disposed about the periphery of the base 100. The springs and pins 130,134 allow the support platform 120 to slide between a normal resting position and an actuated position, which will be discussed in detail below.

Disposed on the inner surface 122 of the support platform 120 are a plurality of annular, concentric base channels 140A-X, which are arranged in an alternating manner with the concentric sensing surfaces 150A-X. That is, the concentric base channels 140A-X, which extend into the inner surface 122 of the support platform 120, are configured to receive the alignment ribs 60A-X of the dispensing container 20 therein, thereby facilitating the alignment of the indicators 80A-X of the dispensing container 20 with the sensing surfaces 150A-X of the support platform 120. It should be appreciated that the alignment ribs 60A-X and the base channels 140A-X may be sized and dimensioned to ensure that only compatible dispensing containers 20 are able to be utilized with the base 100. In other words, if the alignment ribs 60A-X of the dispensing container 20 fail to properly mate with the base channels 140A-X of the support platform 120, the dispensing container 20 will not be properly supported by the support platform 120, making it unstable and incompatible for use with the base 100. In addition, the concentric sensing surfaces 150A-X include sensors, such as a magnetic sensor or capacitive sensor that is configured to detect the presence and non-presence of the indicators 80A-X that are disposed within the indicator channels 70A-X of the dispensing container 20. Thus, when the dispensing container 20 is placed within the receiving cavity 110 of the base 100, the concentric alignment ribs 60A-X of the dispensing container 20 are received within the corresponding base channels 140A-X of the support platform 100. As such, when a compatible dispensing container 20 configured for use with the base 100 is placed upon the support platform 120, the indicators 80A-X are oriented so as to be placed in operative alignment with the sensing surfaces 150A-X of the base 100. In addition, the base 100 includes a base plate 152 that is removably attached thereto to facilitate access to various components of the system 10 to be discussed.

The base 100 also includes a circuit board 188 that is attached to the outer surface 124 of the support platform 120. Specifically, the circuit board 188 includes a controller 190 that provides the necessary hardware and software necessary to carryout the functions to be discussed. Coupled to the controller 190 is a display 192, such as an LED (light emitting diode) display, or any other suitable display. The controller 190 and the display 192 are powered by any suitable power source 194, such as a portable DC (direct current) power source, such as a battery or photovoltaic cell, or such as an AC (alternating current) power source from a standard electrical outlet.

The controller 190 is pre-programmed with dispensing container attribute data that is associated with various stored indicator profiles that are defined by predetermined patterns or arrangements of indicators 80A-X. That is, the controller 190 is configured to store various patterns or arrangements of the indicators 80A-X as indicator profiles, which are associated with dispensing container attribute data that includes various types of information associated with the dispensing container 20 and the material carried therein, including but not limited to: the type of material carried by the dispensing container (soap, moisturizer, or sanitizer), the quantity of material carried by the dispensing container, the date of manufacture of the dispensing container, the expiration date of the material, and the like. As such, when the dispensing container 20 is inserted into the receiving cavity 110 of the base 100, the position of the one or more indicators 80A-X is detected by the sensing surfaces 150A-X of the support platform 120. When the sensing surfaces 150A-X detects a pattern or arrangement of indicators 80A-X that matches one of the pre-programmed indicator profiles stored at the controller 190, the controller 190 presents the dispensing container attribute data associated with the matching indicator profile on the display 192.

Alternatively to associating dispensing container attribute data with each particular indicator profile or arrangement of the indicators 80A-X, as discussed above, the controller 190 may also be configured with the appropriate logic to read or interpret information, including the attribute data discussed above, that is coded by the relative position of the indicators 80A-X. That is, the relative position or arrangement of the indicators 80A-X defines a code, which is readable by the sensing surface 150A-X. Once the code or indicator profile is read, it is then decoded by the controller 190 into information for presentation upon the display 192.

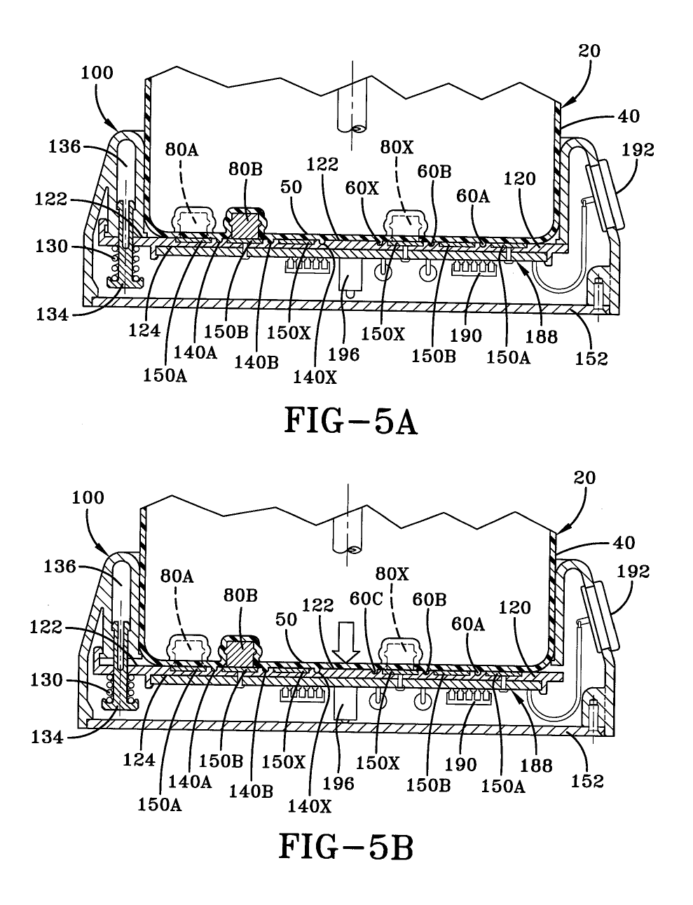

The circuit board 188 also includes an actuation switch 196 that is coupled to the controller 190, and is configured to engage the base plate 152 of the base 100 as the support platform 120 is moved from its normal resting position, shown in FIG. 5A, to an actuated position, shown in FIG. 5B, when the dispensing nozzle 30 of the dispensing container 20 is depressed to dispense material therefrom. That is, as the dispensing nozzle 30 of the dispensing container 20 is depressed, or otherwise actuated, the actuation switch 196 is also actuated, such that a count value maintained at the controller 190 is incremented or updated and presented for viewing via the display 192. As such, the count value serves to identify the total number of dispensing nozzle 30 actuations that have occurred, or dispenses of material that have taken place at the dispensing container 20 over a period of time. In one aspect, the count value maintained by the controller 190 may be reset to a zero count value each time a new dispensing container is inserted onto the base 100, by detecting the presence and non-presence of the indicators 80A-X or by depressing the support platform 120, so as to actuate the switch 196 in a predetermined sequence. It should be appreciated that such a reset configuration may be used by the various other embodiments discussed herein.

Alternatively, the concentric sensing surfaces 150A-X of the mounting base 100 may include switches that are positioned in a manner to be in operative communication with the indicators 80A-X that comprise tabs or protrusions that extend from the indicator channels 70A-X of the base surface 50 of the dispensing container 20. As such, when the dispensing container 20 is inserted into the receiving cavity 110 of the base 100, the tabs comprising the indicators 80A-X actuate one or more switches provided by the sensing surfaces 150A-X of the base 100. When the switches provided by the sensing surfaces 150A-X have been actuated in a configuration that matches one of the pre-programmed indicator profiles stored at the controller 190, the controller 190 indicates via the display 192 dispensing container attribute data that is associated with the stored indicator profile.

The dispensing container attribute data acquired from the readable indicators 80A-X, along with the stored count value may also be processed by the controller 190 to calculate various information, such as the remaining amount of material in the dispensing container 20, usage rates, and any other data for presentation on the display 192.

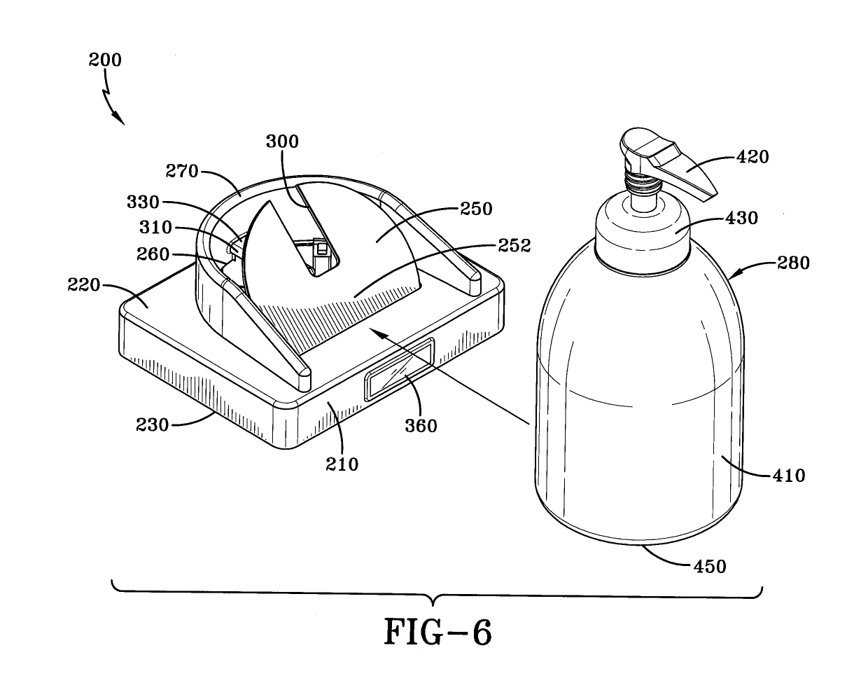

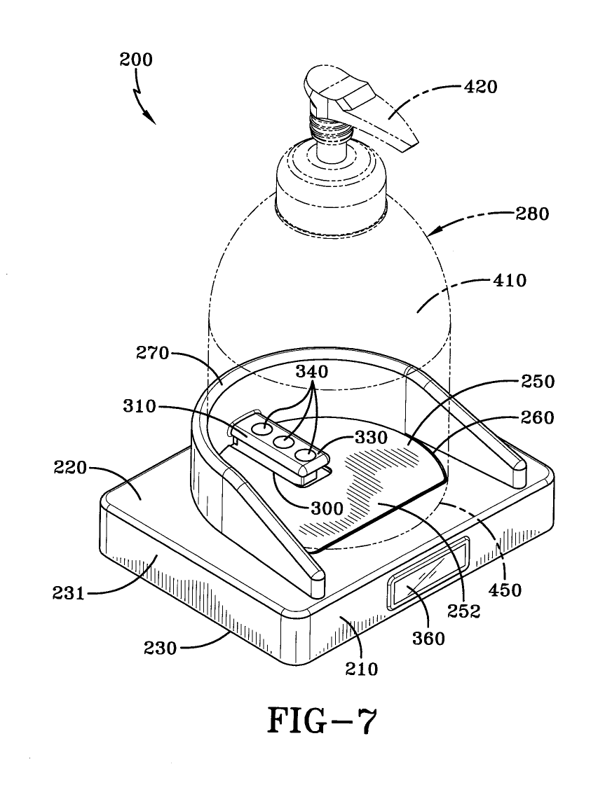

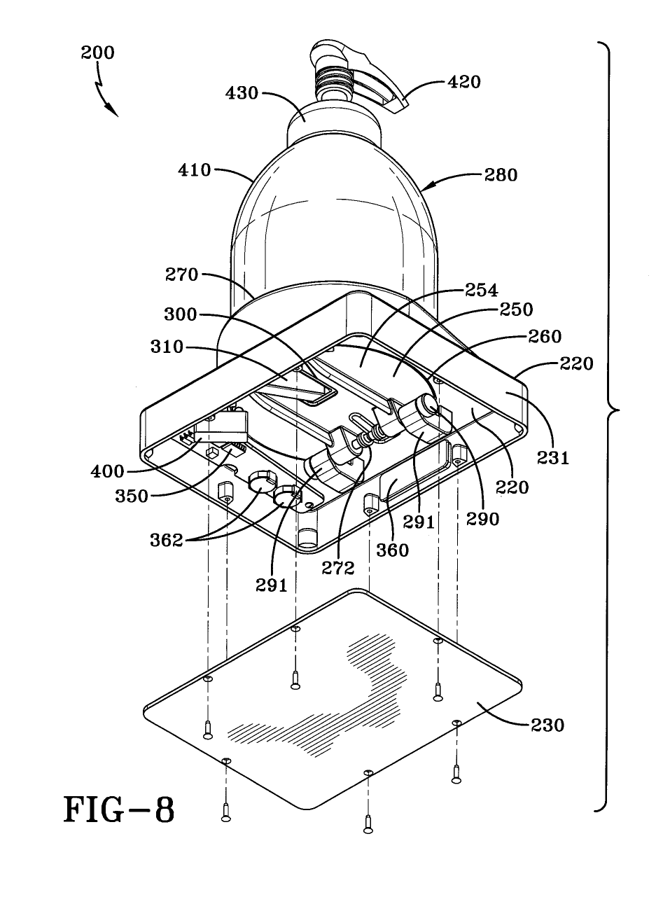

Continuing to FIGS. 6-12, a proprietary dispensing container system referred to by the numeral 200 includes a base 210 having opposed, spaced upper and lower sections 220 and 230 that are joined about their periphery by a wall 231. A support platform 250 having opposed upper and lower surfaces 252 and 254 is pivotably attached within a platform aperture 260 disposed in the upper section 220 of the base 210. Disposed about the periphery of the platform aperture 260 is a guide wall 270 that facilitates the alignment of a portable (disposable/replaceable) dispensing container 280 therein in a manner to be discussed. The support platform 250 is pivotably biased by a spring 272, and is configured to pivot about a shaft 290 carried by bosses 291 provided by the base 210. The support platform 250 includes a key aperture 300 that may comprise any suitable shape, such as a rectilinear shape, a curvilinear shape, or a combination of both to accommodate the passage of a key arm 310 therethrough that extends from the guide wall 270. That is, the key aperture 300 is configured to receive the key arm 310 therethrough as the support platform 250 is pivoted in a manner to be discussed. Moreover, the support platform 250 is configured to be positioned or biased, such that when the dispensing container 280 is not attached the support platform 250, the support platform 250 is placed in an initial position whereby it extends upward, away from the upper section 220 of the base 210 at an oblique angle, as shown in FIG. 6, while allowing the key arm 250 to pass through the key aperture 300.

The key arm 310 includes a sensing surface 330 that includes one or more sensors 340 that are coupled to a controller 350 that includes the necessary hardware and software necessary to carryout the functions to be discussed. It should be appreciated that the sensors 340 may comprise any suitable sensing or electronic reading system, such as a magnetic sensor, optical sensor, capacitive sensor, or RFID (radio frequency identification) reader for example. Specifically, the sensors 340 are configured to obtain dispensing container attribute data relating to the dispensing container 280 and the material carried therein from an electronically readable data token or indicator carried by the dispensing container 280, which will be discussed in detail below.

In addition, a display 360, such as an LCD (liquid crystal display) display, is also coupled to the controller 350 to present various data, such as the dispensing container attribute data to be discussed. A power source 362 is coupled to the controller 350 and may comprise any suitable source of power, including a portable DC (direct current) power source, such as a battery or photovoltaic cell for example, or may alternatively comprise an AC (alternating current) power source, such as a standard electrical outlet. In addition, the base 210 includes an actuation switch 400, such as a micro-switch, which is also coupled to the controller 350 and that is in operative contact with the lower surface 254 of the support platform 250. Thus, when the support platform 250 is rotated or pivoted downward through the platform aperture 260 of the base 210, the switch 400 is actuated. In particular, the switch 400 increments or updates a count value maintained at the controller 350 each time the switch 400 is actuated, so as to count the number of times the dispensing container 280, which is carried upon the support platform 250 has been actuated by a user in the manner to be discussed.

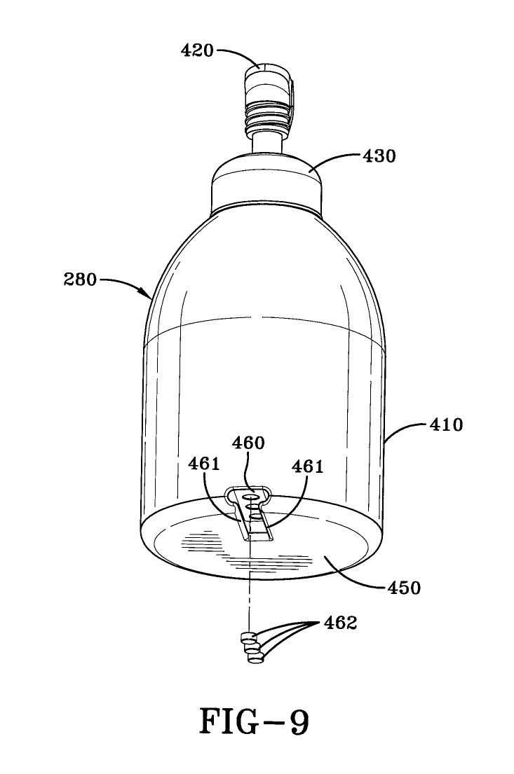

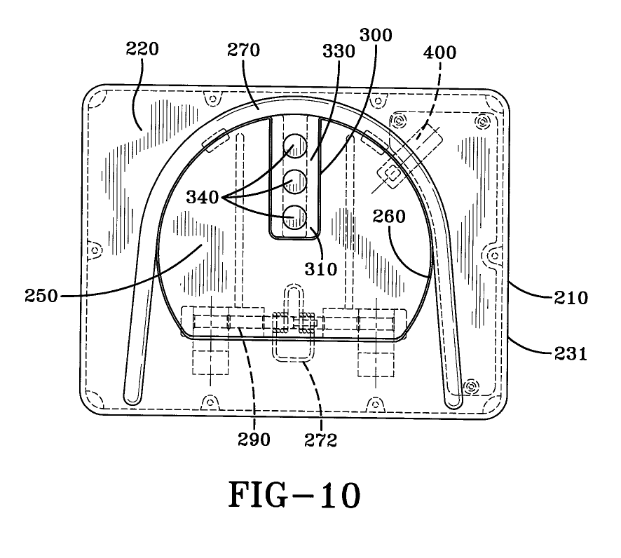

The dispensing container 280, as shown in FIG. 9, includes a vessel 410 that carries any desired material, such as soap, sanitizer, or moisturizer for example. Material is dispensed from the vessel 410 from a dispensing nozzle 420 that actuates a pump 430 when depressed. Thus, as the user actuates the pump 430 by pressing downward on the dispensing nozzle 420, material from the vessel 410 is dispensed therefrom. The vessel 410 also includes a bottom surface 450 that includes a receiving aperture 460 that is dimensioned to slideably receive the key arm 310 of the base 210 therein, as shown in FIG. 10. It should be appreciated that the receiving aperture 460 of the dispensing container 280 and the key arm 310 of the base 210 may take on any compatible or complementary shape and/or dimension. For example, the key arm 310 of the base 210 may comprise an elongated rectangular section, while the receiving aperture 460 comprises a rectangular slot, such that the retention sections 461 are disposed beneath the key arm 310 to prevent the dispensing container 280 from being lifted upward away from the key arm 310 by the upward spring bias of the support platform 250. That is, the retention sections 461 prevent the dispensing container 280 from being lifted off of the base 210 by the rotation of the spring biased support platform 250 in a manner to be discussed.

Disposed within the receiving aperture 460 of the dispensing container 280 is one or more electronically readable data tokens or indicators 462, which may comprise any electronically readable indicia, or other electronically readable medium, such as magnets, magnetic strips, bar codes, RFID (radio frequency identification) tags, or any other medium that is readable or otherwise capable of being sensed or detected by one or more sensors 340 provided by the base 210. For example, the indicators 462 may comprise magnets that can be arranged in any desired configuration, which identify the particular dispensing container attribute data associated with the dispensing container 280 and the material carried therein. As such, the controller 350 is pre-programmed with dispensing container attribute data that is associated with one or more indicator profiles that are each defined by various predetermined patterns or arrangements of the indicators 462. That is, the controller 190 is configured to associate each of the various stored patterns or arrangements of the indicators 462 (i.e. indicator profile) with dispensing container attribute data that includes various types of information associated with the dispensing container 280 and its contents, including but not limited to: the type of material carried by the dispensing container, the quantity of material carried by the dispensing container, the age of the dispensing container, the expiration data of the material, and the like.

Alternatively, the indicators may also comprise data tokens 462 that are configured to contain information relating to various dispensing container attribute data associated with the dispensing container 280 and its contents, including but not limited to: the type of material carried by the dispensing container 280, the quantity of material contained in the dispensing container 280, and the date of manufacture of the material in the dispensing container 280 for example. In one aspect, the data tokens 462 may comprise magnets that are positioned or arranged in various orientations, so as to identify the various dispensing container attribute data regarding the dispensing container 280 and its contents. The dispensing container attribute data acquired from the readable data token 462, along with the stored count value may be processed by the controller 350 to calculate various information, such as the remaining amount of material in the dispensing container 280, usage rates, and any other data for presentation on the display 360.

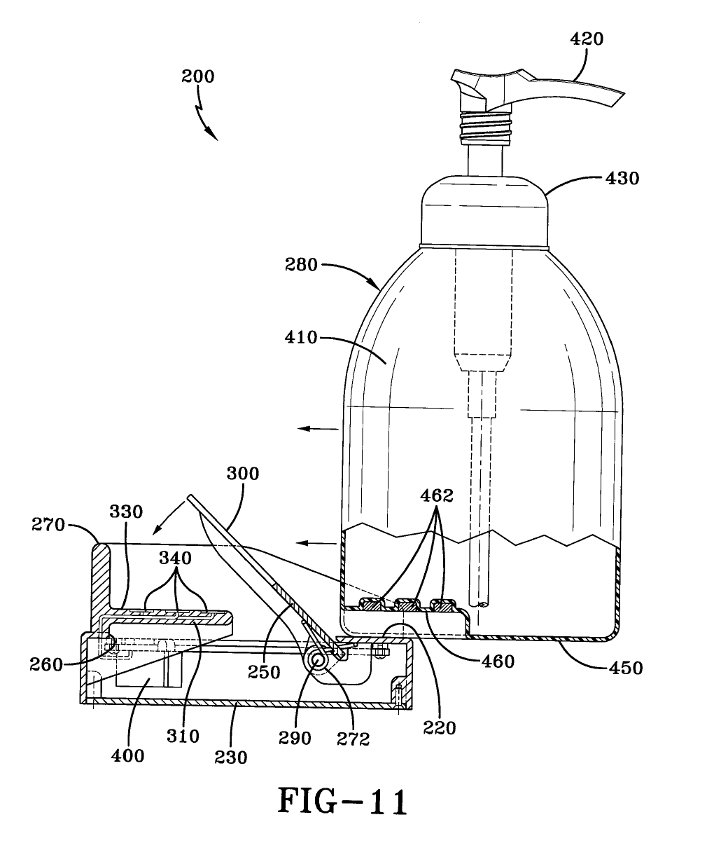

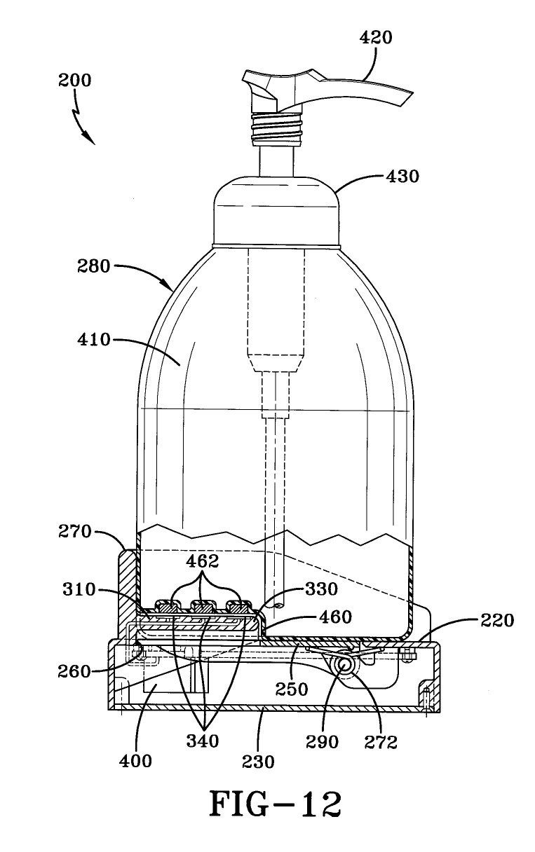

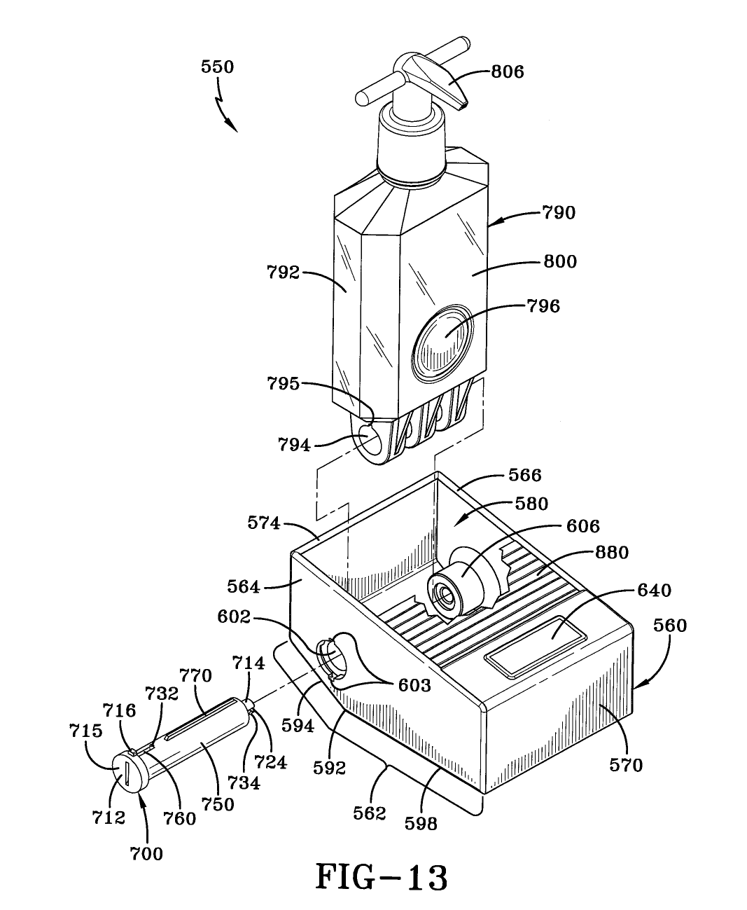

In order to place the dispensing system 200 into operation, the support platform 250 is rotated downward from its initial angled position, as shown in FIG. 11, to an operating position such that the support platform 250 is substantially horizontal with the upper section 220 of the base 210, as shown in FIG. 12. The downward rotation of the support platform 250 to the operating position overcomes the bias of the spring 272, and positions the support platform 250 so that it is substantially horizontal with the upper section 220 of the base 210, allowing the key arm 310 to extend fully through the key aperture 300 of the support platform 250. Next, the key arm 310 is inserted within the receiving aperture 460 of the vessel 410. As a result, the dispensing container 280 is retained to the base 210, while the support platform 250 is retained at a substantially horizontal position relative to the upper section 220 of the base 210. Once the dispensing container 280 is attached to the key arm 310, the sensing surface 330 and its sensors 340 detect the position or arrangement of the one or more indicators 462 carried by the dispensing container 280. When the sensing surface 330 detects a pattern or arrangement of indicators 462 that matches the arrangement defined by one of the pre-programmed indicator profiles at the controller 350, the controller 350 presents the dispensing container attribute data associated with the matching indicator profile on the display 360.

Alternatively, in the case of data tokens 462, when the dispensing container 280 is attached to the base 210, the sensors 340 read or otherwise directly acquire the dispensing container attribute data stored in or defined by the one or more data tokens 462 carried by the dispensing container 280.

Furthermore, the rotation of the support platform 250 to the operating position, whereby it is substantially horizontal with the upper section 220 of the base 210, also brings the lower surface 230 of the support platform 250 into operative contact with the switch 400. The dimension of the receiving aperture 460, as well as the position of the retention sections 461 provided by the dispensing container 280 allows the dispensing container 280 to slide or translate up and down on, and with respect to, the key arm 310, while the spring 272 continues to bias the dispensing container 280 upward via the support platform 250. Thus, as the user depresses the dispensing nozzle 420 to dispense material from the vessel 410, the support platform 250 pivots or rotates downward to actuate the switch 400, thereby incrementing the count value maintained at the controller 350. In other words, each time the dispensing container 280 is actuated to dispense material when the dispensing container 280 is attached to the base 210, the support platform 250 is rotated downward through the platform aperture 260 by the application of force from the user's hand, so as to actuate the switch 400 causing the count value at the controller 350 to be incremented or updated It should also be appreciated that the count value maintained at the controller 350, the various other information or data obtained from reading the indicators or data tokens 462, as well as various other information calculated by the controller 350 based on such information, may be presented to a user of the system 10 via the display 360.

Thus, the base 210 only permits authorized dispensing containers 280 that have a key aperture 460 that is compatible for receiving the shape/dimension of the key arm 310 to be used therewith, as the spring biased support platform 250 will not be maintained or retained in a substantially horizontal position to properly support the dispensing container 280 if an incompatible dispensing container is used. For example, in the event an unauthorized dispensing container is attempted to be attached to the key arm 310 of the base 210, which fails to include a complementary or compatibly shaped/dimensioned retention aperture 460, the upward spring bias of the normally angled support platform 250 ejects the dispensing container from the base 210, preventing the unauthorized dispensing container from being securely rested thereon, thus preventing the use of the unauthorized dispensing container.

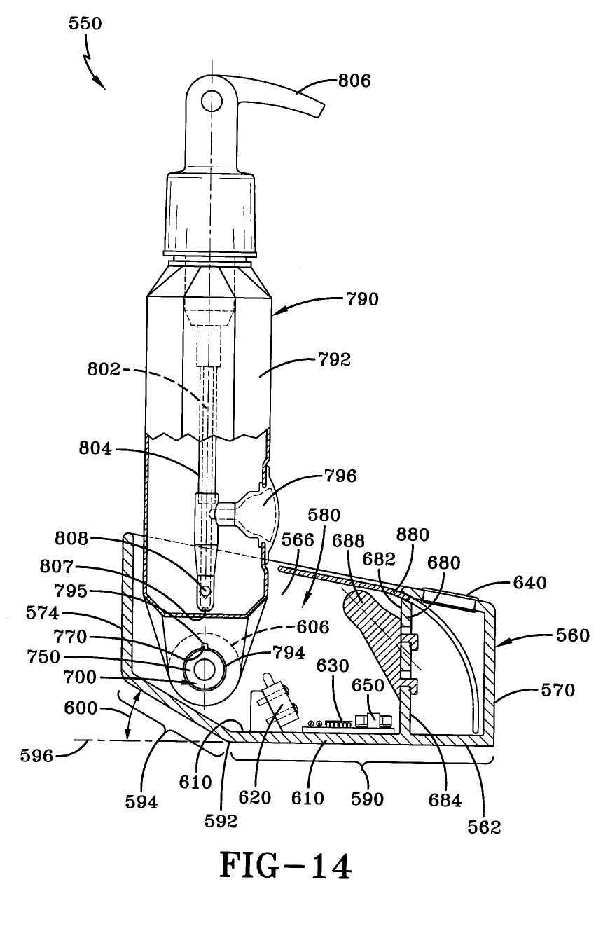

Another embodiment of a proprietary dispensing container system is referred to by numeral 550, as shown in FIGS. 13-21 of the drawings. Specifically, the proprietary dispensing container system 550 includes a base 560 having a base section 562 that is bounded by opposed lateral sections 564 and 566 and by front and rear sections 570 and 574 that extend from the base section 562 to form a cavity 580. The base section 562 comprises a resting section 590 that extends from the front section 570 to a pivot edge 592, while an angled or tapered pivot section 594 extends upward, away from the resting section 590, to the rear section 574 of the base 560. As such, when the base 560 is placed on a flat support surface 596, such as a table or counter-top, as shown in FIG. 14, the resting section 590 supports the base 560 on the surface 596, while the pivot section 594 that is angled away from the resting section 590 is elevated above the surface 596, forming a tapered gap 600 between the flat support surface 596 and the pivot surface 594 of the base section 562.

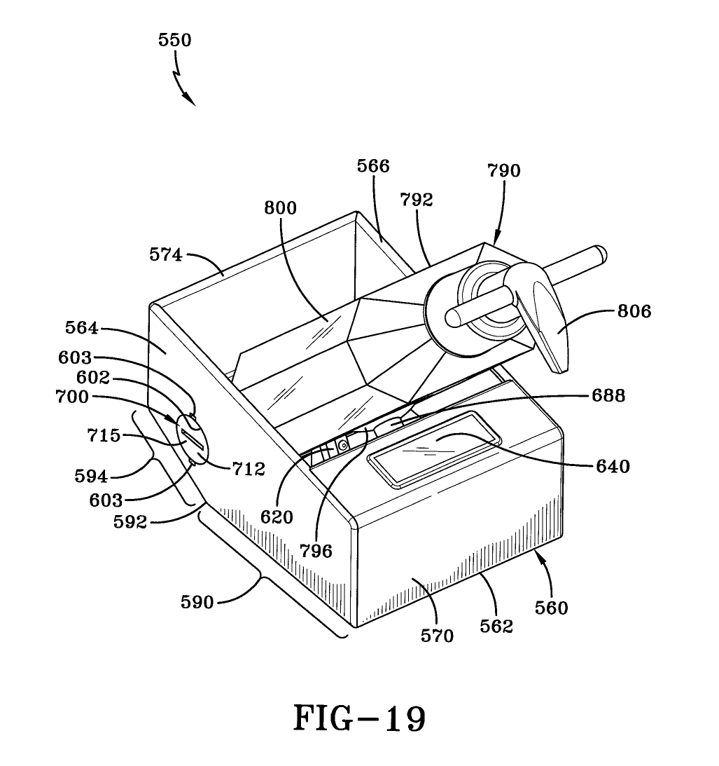

An annular pivot aperture 602 having one or more lock apertures 603 disposed about its periphery is disposed through the lateral section 564, while a pivot collar 606 axially aligned therewith is disposed on an inner surface of the lateral section 566 of the base 560. Extending from the inner surface 610 of the resting section 590 is an actuation switch 620 that is coupled to a controller 630 and a display 640, such as a liquid crystal display (LCD), as shown in FIGS. 14 and 18. It should be appreciated that the controller 630 includes the necessary hardware and software necessary to carryout the functions to be discussed. The controller 630 and the display 640 may be powered by any suitable power source 650, such as a portable DC (direct current) power source, such as a battery or photovoltaic cells for example, as well as an AC (alternating current) power source, such as a standard electrical outlet. Also extending from the inner surface 610 of the resting section 590 is a support section 680 that extends between lateral sections 564 and 566 of the base. The support section 680 includes an inner surface 682 and an outer surface 684, such that an angled plunger or protrusion 688 extends from the inner surface 682 of the support section 680 into the cavity 580 of the base 560.

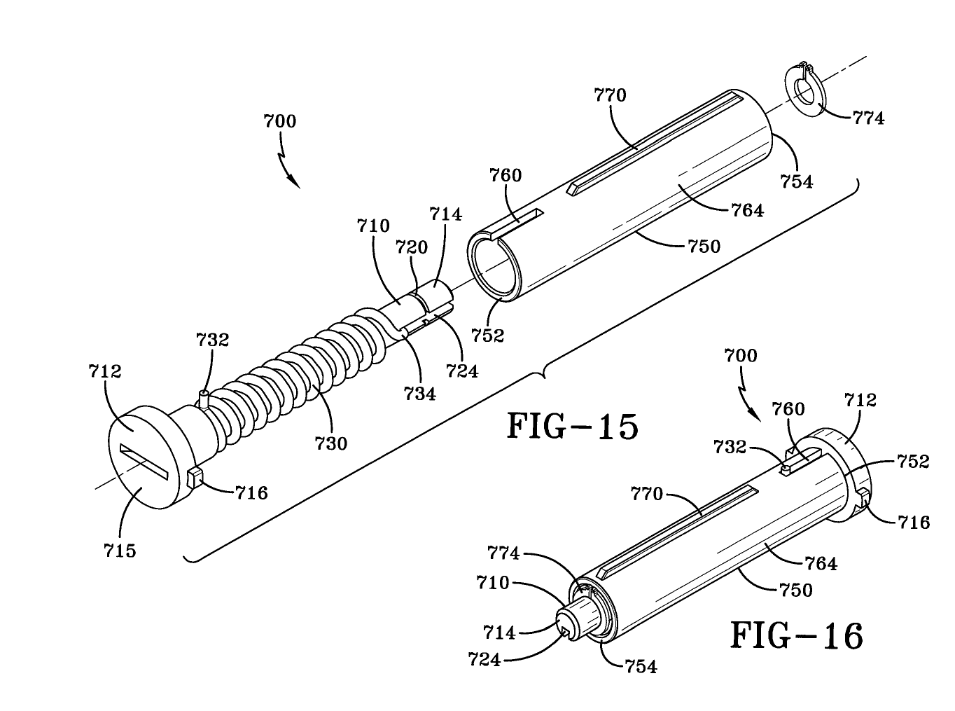

Disposed within the cavity 580 of the base 560 is an actuation assembly 700, as shown in FIGS. 15 and 16, which comprises a support shaft 710 having opposed attachment and receiving ends 712 and 714. Disposed at the end 712 of the shaft 710 is a lock cap 715 that includes a lock tab 716. The support shaft 710 also includes a clip channel 720 that circumscribes the support shaft 710 at a point that is adjacent to the receiving end 714 of the shaft 710. In addition, the support shaft 710 also includes a linear retention channel 724 that extends from the receiving end 714 of the support shaft 710 along a portion of its length. The support shaft 710 extends through an elongated spring 730, such that one end of the spring 730 is attached to the support shaft 710. Specifically, the spring 730 includes opposed ends 732 and 734, such that end 734 of the spring 730 is configured to be received within the retention channel 724 of the support shaft 710, while the remaining end 732 of the spring 730 is provided proximate to the attachment end 712 of the support shaft 710. In one aspect, the ends 732,734 of the spring 730 comprise tabs that extend at a substantially right angle from the longitudinal axis of the spring 730 and the support shaft 710.

The support shaft 710 and spring 730 are received within an elongated and substantially cylindrical pivot sleeve 750. Specifically, the pivot sleeve 750 includes opposed ends 752 and 754, such that the receiving end 714 of the support shaft 710 is adjacent to end 754 of the pivot sleeve 750, and the attachment end 712 of the support shaft 710 is adjacent to end 752 of the pivot sleeve 750. In addition, the pivot sleeve 750 includes an alignment slot 760 that is positioned adjacent to the end 752 of the pivot sleeve 750 and that is configured to receive the end 732 of the spring 730 that is proximate to the attachment end 712 of the support shaft 710 therein. Extending at a substantially right angle from an outer surface 764 of the pivot sleeve 750 is an alignment protrusion 770. The pivot sleeve 750 is retained to the support shaft 710 by a retention clip 774 that is compressively received in the clip channel 720. As such, the pivot sleeve 750 is resiliently biased to the support shaft 710 by the spring 730, such that when the pivot sleeve 750 rotates against the force applied by the spring 730, and relative to the support shaft 710, the pivot sleeve 750 rotates back to its original position when released.

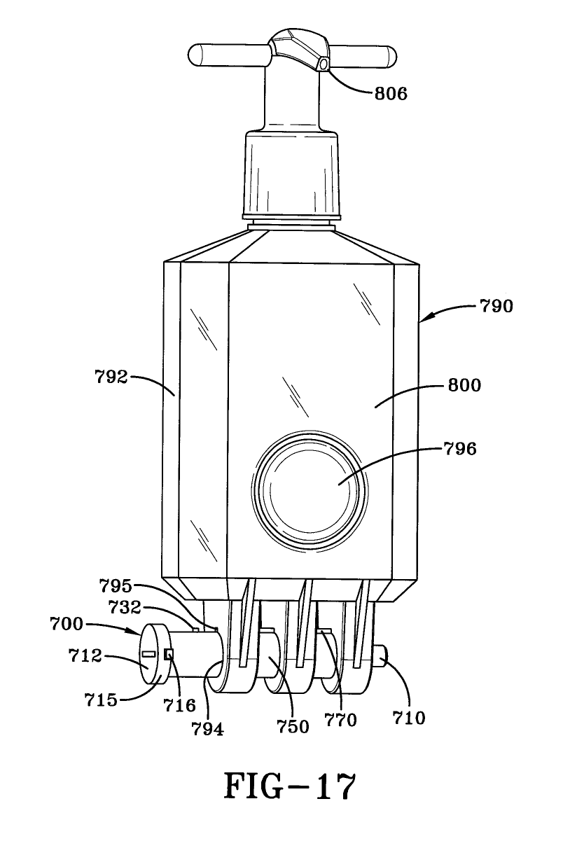

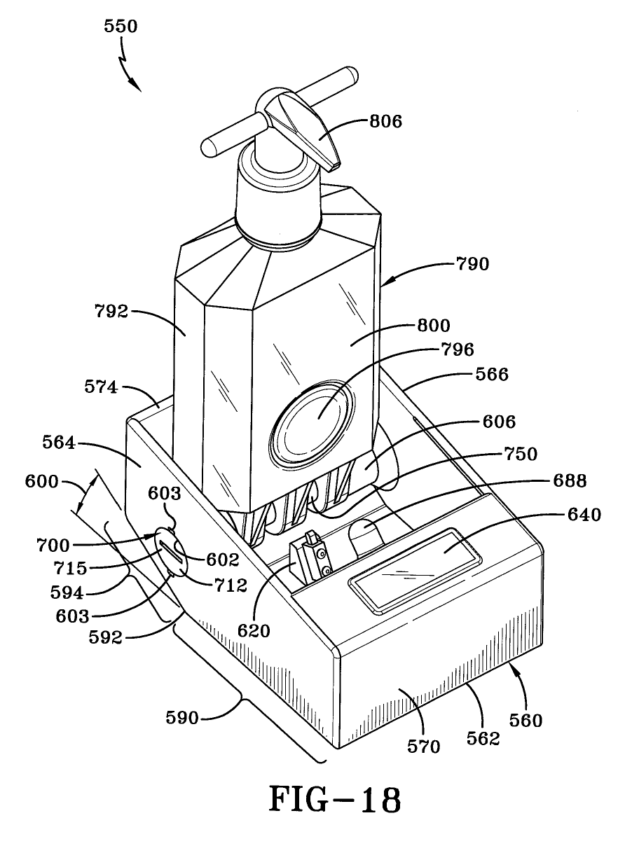

The base 560 is configured for use with a portable (disposable/replaceable) dispensing container 790, shown in FIG. 17, which includes a vessel 792 that is configured to carry any suitable material, such as soap, sanitizer, or moisturizer for example. The dispensing container 790 also includes an attachment aperture 794 that is configured to receive the pivot sleeve 750 therein. In particular, the attachment aperture 794 is configured with a key slot 795 that is configured to receive the alignment protrusion 770 of the pivot sleeve 750 therein. In order to dispense material, the dispensing container 790 includes a dome pump 796 that is carried on an outer surface 800 of the vessel 792, which is fluidly coupled by a tube 802 to a dispensing nozzle 806, as shown in FIG. 14. The tube 802 also includes an inlet 807 that is configured to draw the liquid material from the vessel 792 into the tube 802 for delivery to the dome pump 796. In addition, a one-way valve 808 is placed in-line with the tube 802 at a point between the dome pump 796 and the inlet 807. As such, the one-way valve 808 serves to only allow liquid material to be drawn out of the dispensing container 790 via the inlet 807 and into the dome pump 796 when the dome pump 796 transitions from a compressed state (i.e. actuated state) to a non-compressed (i.e. resting state). Alternatively, the one-way valve 808 diverts the liquid material out of the dispensing nozzle 806 when the dome pump 796 transitions from a non-compressed state (i.e. resting state) to is in a compressed state (i.e. actuated state). Specifically, the dome pump 796 is actuated by its compression that is imparted by the angled plunger or protrusion 688 that extends from the inner surface 682 of the support section 680 of the base 560 in a manner to be discussed.

In order to place the dispensing system 550 into operation, the dispensing container 790 is placed within the cavity 580 of the base 560, as shown in FIG. 18. Next, the attachment aperture 794 of the dispensing container 790 is axially aligned with the annular pivot aperture 602 and annular pivot collar 606 of the base 560. Once aligned, the actuation assembly 700, which includes the support shaft 710, spring 730 and the pivot sleeve 750, is inserted through the pivot aperture 602 of the base 560 and the attachment aperture 794 of the vessel 792, whereupon the receiving end 714 of the support shaft 710 is received in the pivot collar 606 of the base 560. Furthermore, the pivot sleeve 750 is configured to be received within the attachment aperture 794 of the vessel 792, such that the alignment protrusion 770 of the pivot sleeve 750 is received within key slot 795 of the dispensing container 790, so as to lock the dispensing container 790 to the pivot sleeve 750. Finally, to prevent the actuation assembly 700 from coming loose from the base 560, lock tabs 716 of the lock cap 715 provided by the actuation assembly 700 are received in the corresponding lock apertures 603 of the base 560. As such, the lock cap 715 is rotated to allow the lock tabs 716 to be secured in corresponding detents in the base 560, while a lock spring (not shown) carried within the pivot collar 606 retains the lock tabs 716 in the detents.

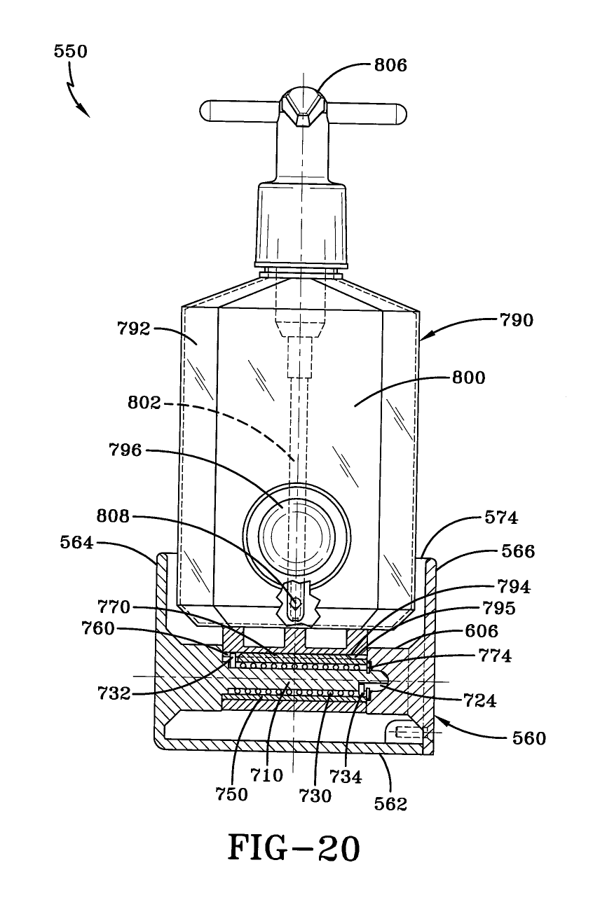

Once the dispensing container 790 is attached to the pivot sleeve 750 of the actuation assembly 700, the dispensing container 790 is permitted to rotate or pivot with respect to the support shaft 710. The spring 730 serves to counter the rotation of the dispensing container 790 toward the protrusion 688, so as to bias or otherwise position dispensing container 790 at its normal resting position, as shown in FIG. 18, such that the dome pump 796 is maintained out of contact with the plunger 688. However, when a user desires to dispense material from the dispensing container 790, he or she rotates the dispensing container 790 from its initial or normal resting position, as shown in FIG. 18, toward the front section 570 of the base 560, so that the dome pump 796 is compressed by the protrusion 688, as shown in FIG. 19. That is, the pivot sleeve 750 rotates upon the support shaft 710 to allow the dispensing container 790 to pivot or rotate so that the dome pump 796 engages or is otherwise compressed by the protrusion 688. As the dome pump 796 is compressed and the dispensing container 790 is rotated, the one-way valve 808 remains closed, and the liquid material carried by the dome pump 796 is forced through the tube 802 and dispensed from the dispensing nozzle 806.

In addition, the rotation of the dispensing container 790 toward the protrusion 688 causes the dispensing container 790 to contact the switch 620 to update or increment a count value stored at the controller 630. As such, the count value indicates the number of times material has been dispensed from the dispensing container 790 by the system 550. It should also be appreciated that the count value may be utilized with other information stored or acquired remotely by the controller 630 to generate usage rates, to predict when the material in the dispensing container will be fully consumed, as well as to generate any other desired statistics. It is also contemplated that such information generated by the controller 630 may be presented upon the display 640 for review by a user or other individual.

Finally, after the material has been dispensed from the dispensing container 790, the dispensing container 790 is released, whereupon the spring 730 rotates the pivot sleeve 750 and dispensing container 790 carried thereby away from the protrusion 688 back to its normal resting position, as shown in FIG. 18. Simultaneously with the return of the dispensing container 790 to its normal resting position, the dome pump 796 transitions from its compressed or actuated state to its normal resting state, thus forming a vacuum that opens the one-way valve 808. This allows material to be drawn through the inlet 807 of the tube 802 from the dispensing container 790, whereupon it passes through the one-way valve 808 and into the dome pump 796 for dispensing during a subsequent actuation of the dome pump 796 by the protrusion 688.

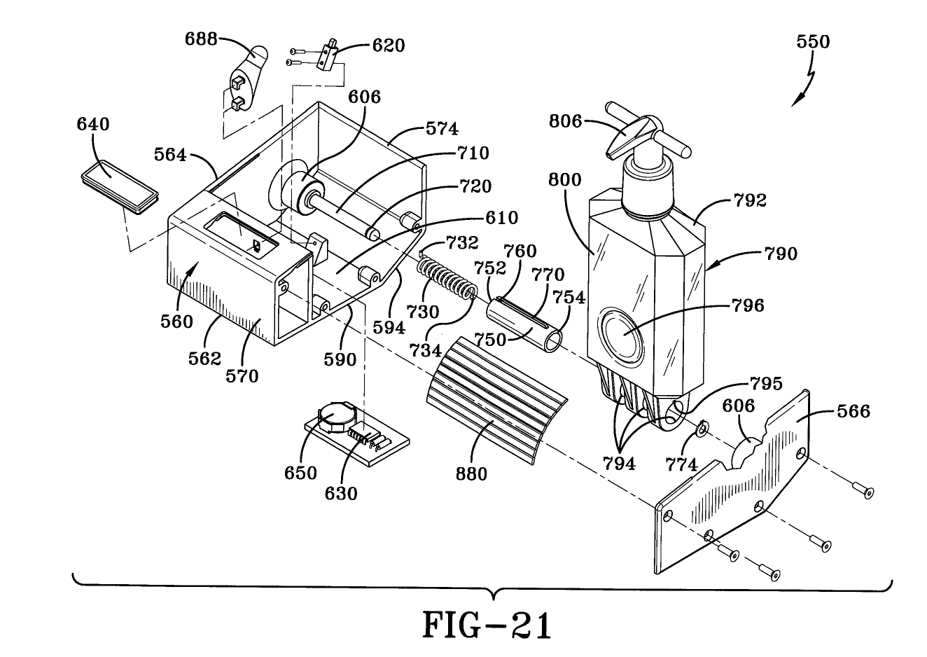

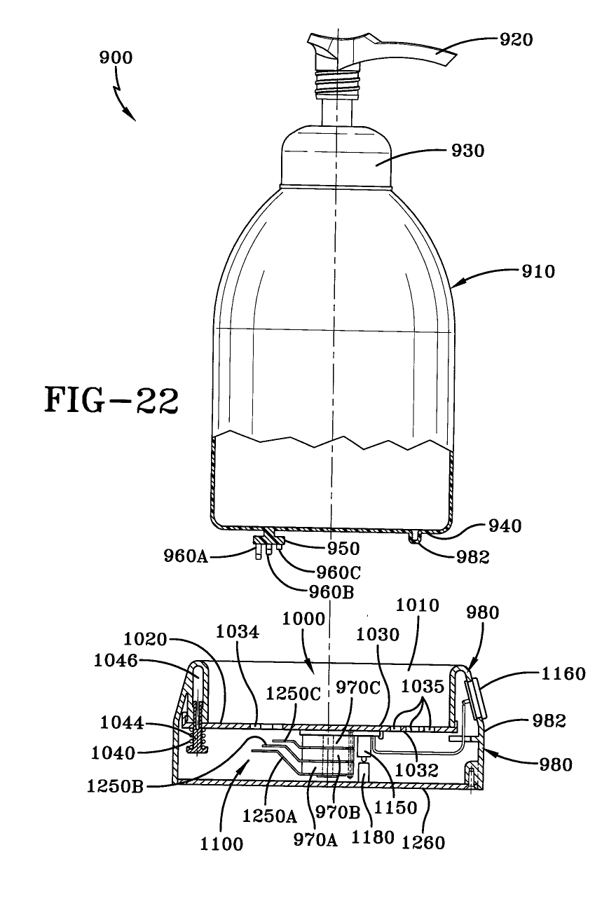

It is also contemplated that the actuation assembly 700, which includes the support shaft 710, spring 730, pivot sleeve 750, and clip 774, is made integral with the base 560, as shown in FIGS. 20 and 21. For example, the attachment end 712 of the support shaft 710 may be made integral with the lateral section 564 of the base 560, such that the pivot sleeve 750 extends from the lateral section 564 at a substantially right angle. In addition, the opposed lateral section 566 may be removed from the base 560 via screws or other suitable fastener to facilitate the attachment and removal of dispensing containers 790 to the pivot sleeve 750.

In the event that an unauthorized dispensing container having a manually actuated pump and dispensing nozzle, such as the pump 430 and the nozzle 420 of dispensing container 280, is attached to the base 560, the pivot edge 592 and angled section 594 serves to prevent its operation. That is, unauthorized dispensing containers, which utilize a pump that must be compressed downward by a user's hand in a substantially vertical direction to dispense material cause the base 560 to pivot at the edge 592. This causes the resting section 590 of the base 560 to lift off of the counter surface 596 as the pivot section 594 of the base section 562 rotates through the gap 600, such that the pivot section 594 contacts the support surface 569. This rocking motion on the pivot edge 592 makes the base 560 unstable, and thus interferes with the normal dispensing of material from the unauthorized dispensing container, thereby deterring the use of such unauthorized dispensing containers in the base 560.

It is also contemplated that the base 560 may include a flexible sliding cover 880 that serves to protect the various components therein, such as the switch 620, the controller 630, and the power source 650, for example. In one aspect, the cover 880 may be biased by a spring or other mechanism to accommodate the rotation of the dispensing container 790 between its normal and active positions.

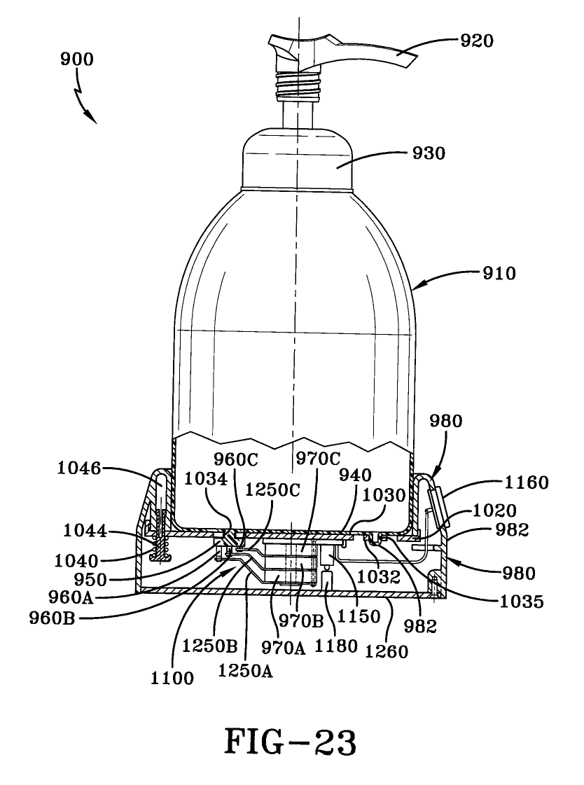

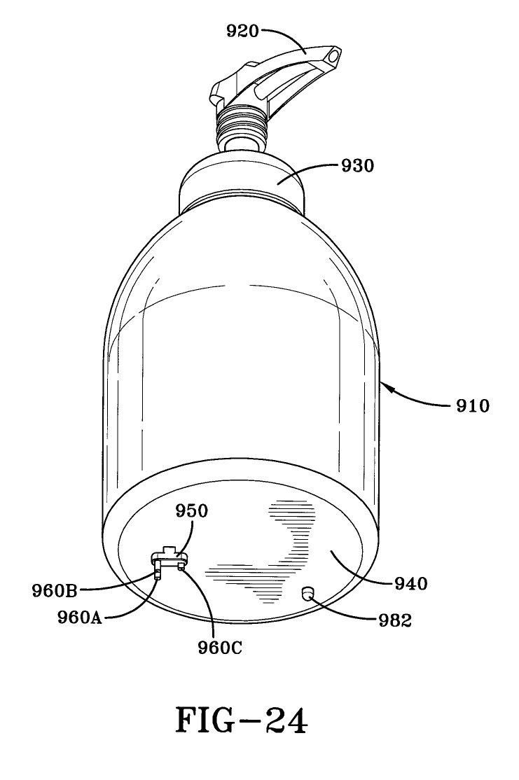

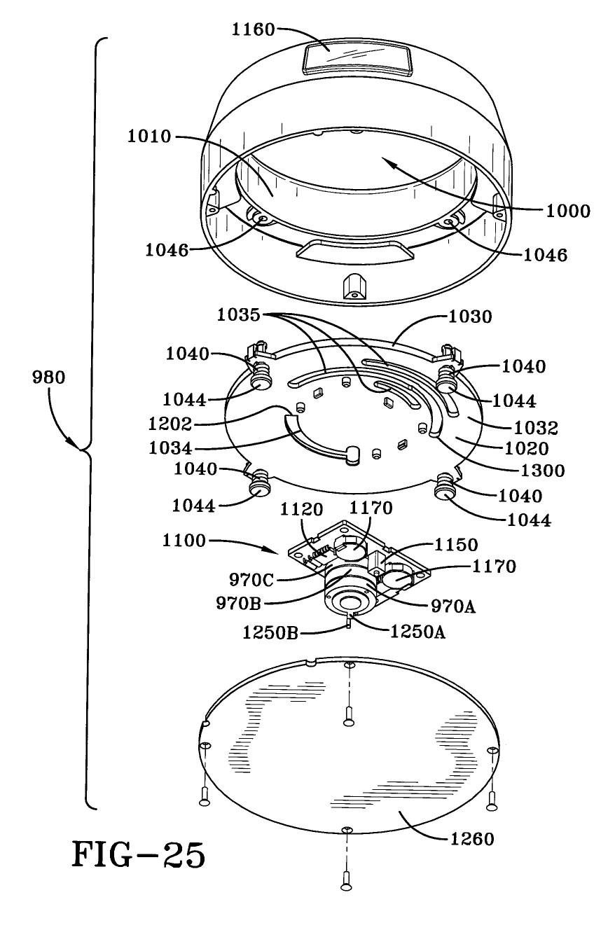

In another embodiment, a proprietary dispensing container system is generally referred to by numeral 900, as shown in FIGS. 22-28 of the drawings. The dispensing system 900 utilizes a portable (disposable/replaceable) dispensing container 910 that dispenses any suitable material, such as soap, sanitizer, and moisturizer for example from a dispensing nozzle 920, when a pump 930 in fluid communication therewith is actuated by the compression of the dispensing nozzle 920. The dispensing container includes a base surface 940 having an engagement arm 950 that includes one or more control tabs 960A-C that are configured to rotate one or more potentiometers 970A-C maintained in a base 980 that is configured to carry the dispensing container 910 in a manner to be discussed. Specifically, the control tabs 960A-C may be of various lengths and shapes. A stop tab 982 also extends at a substantially right angle from the base 940 of the dispensing container 910, and serves to limit the rotation of the dispensing container 910 to a predefined or predetermined amount when positioned on the base 984.

The base 980 includes a housing 982 having an annular receiving cavity 1000 that is bounded by an annular wall 1010 and support platform 1020 upon which the base 940 of the dispensing container 910 rests. The support platform 1020 includes an upper surface 1030 and opposed lower surface 1032 through which one or more arcuate guide slots 1034 and one or more arcuate stop slots 1035 are disposed. The support platform 1020 is suspended upon springs 1040 that are retained by pins 1044 attached to retaining apertures 1046 disposed in the base 980. As such, the support platform 1020 is allowed to slide relative to the base 940 between a normal resting position and a depressed actuated position, which will be discussed in detail below.

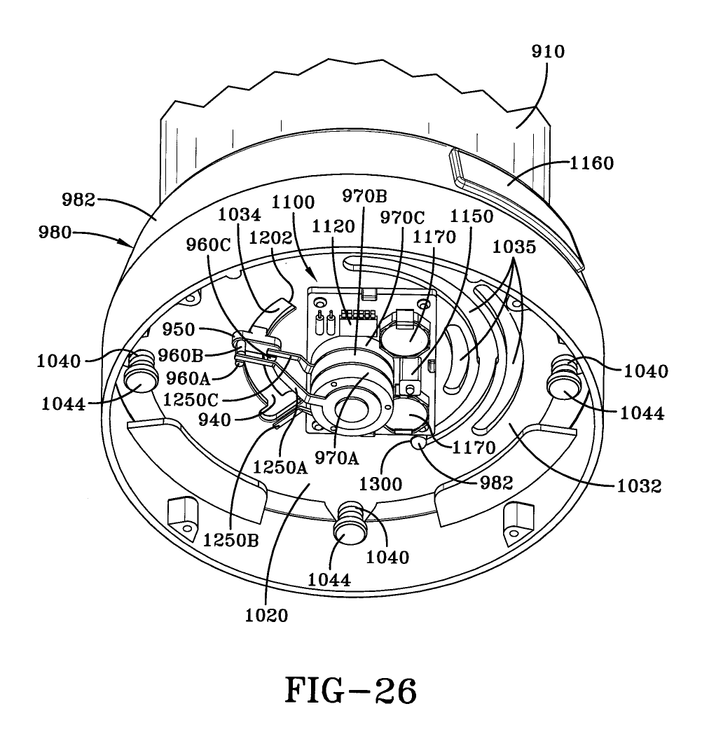

Attached to the lower surface 1032 of the support platform 1020 is a detection system 1100, as shown in FIG. 25, which comprises a controller 1120 that is coupled to the plurality of rotating potentiometers 970A-C. Specifically, the controller 1120 includes the necessary hardware and software to carryout the functions to be discussed. The controller 1120 is also coupled to an actuation switch 1150 and to a display 1160, such as an LCD (liquid crystal display) display. Furthermore, the detection system 1100 is powered by any suitable power source 1170, such as a portable DC (direct current) power source that includes a battery or photovoltaic cell for example, or may alternatively comprise an AC (alternating current) power source, such as a standard electrical outlet.

The potentiometers 970A-C are configured to rotate in a 360-degree manner, and are arranged in a stacked configuration, such that they are axially aligned along a common axis of rotation. Extending from each of the potentiometers 970A-C are corresponding actuation arms 1250A-C of varying lengths that are configured to operatively contact one or more control tabs 960A-C provided by the dispensing container 910. Moreover, the actuation arms 1250A-C rotate about a common axis and may take on any length or shape. As such, the arrangement or configuration of the control tabs 960A-C (i.e. the length, position, etc.) of the dispensing containers 910, which determines the amount of rotation that is imparted to each of the potentiometers 970A-C, are configured to identify various dispensing container attribute data associated with the dispensing container 910 and the material carried thereby including, but not limited to: the type of material, the quantity of material, the date of manufacture, and the like. That is, the controller 1120 is pre-programmed with dispensing container attribute data that is associated with various reference profiles that are each defined by a predetermined amount of rotation of each of the potentiometers 970A-C. In other words, the controller 1120 stores a lookup table that associates the amount of rotation of one or more of the potentiometers 970A-C with associated dispensing container attribute data.

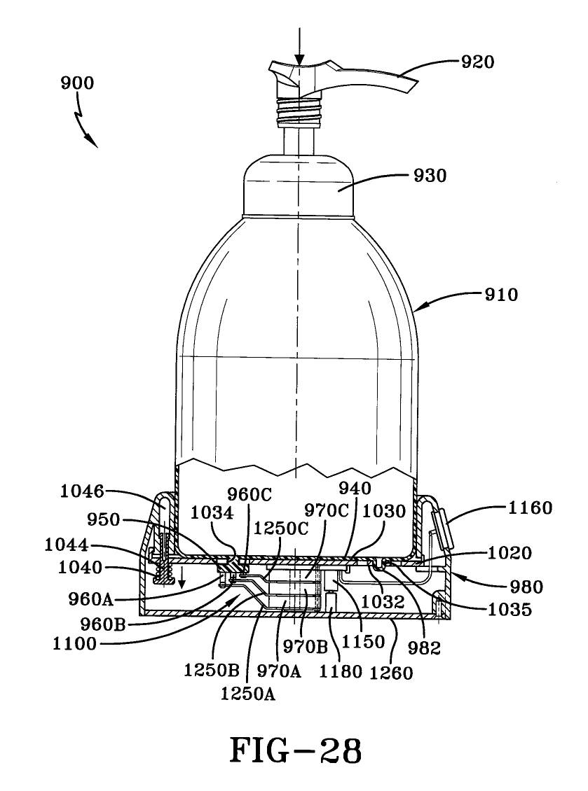

In addition, the actuation switch 1150, which may comprise a micro-switch, is configured to be in operative engagement with a plunger arm 1180 that extends at a substantially right angle from a cover section 1260 that is attached to the bottom of the base 980 disposed opposite to the support platform 1020. Thus, as the support platform 1020 is moved downward from its normal resting position, shown in FIG. 27, to an actuated position, shown in FIG. 28, the actuation switch 1150 is actuated by the plunger arm 1180 so as to update an actuation count value stored at the controller 1120. As such, the actuation count value defines the number of times the dispensing container 910 has been actuated.

Furthermore, the display 1160 is configured to present various information, including the actuation count value, as well as various other dispensing container attribute data acquired by the controller 1120 from the rotation of the potentiometers 970A-C imparted by the control tabs 960A-C discussed above.

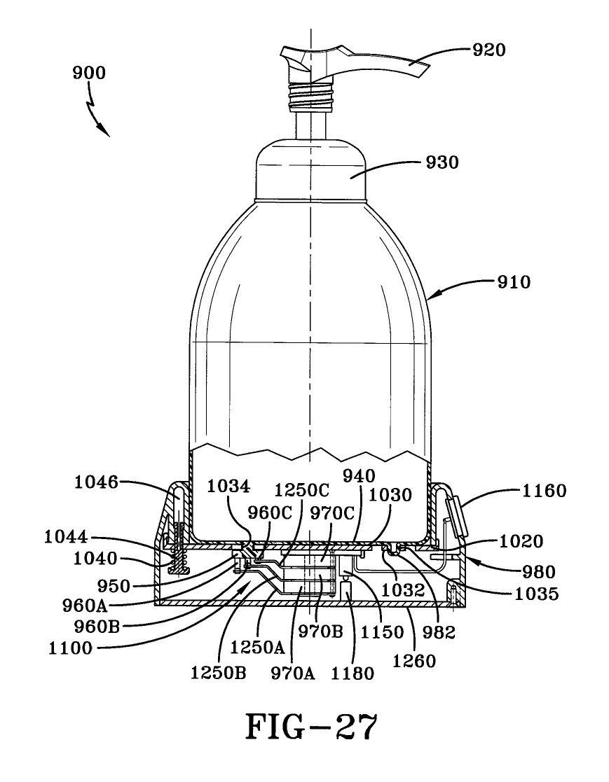

During operation of the dispenser 900, the dispensing container 910 is placed in the receiving cavity 1000, such that the base surface 940 of the dispensing container 910 rests upon the support platform 1020, as shown in FIG. 27. This allows the engagement arm 950 to extend through the guide slot 1034 of the support platform 1020 and the stop tab 982 to extend through one of the stop slots 1035, as shown in FIG. 26. Next, the dispensing container 910 is rotated until the stop tab 982 engages a stop edge 1300 of the stop slot 1035 in the support platform 1020, as shown in FIG. 26. As the stop tab 982 is rotated into its stopped position in the stop slot 1035, the engagement arm 950 moves within the guide slot 1034 so that the control tabs 960A-C contact and rotate the potentiometer arms 1250A-C, so that the potentiometers 970A-C are rotated by a predetermined amount. As such, if the amount of rotation of the potentiometers 970A-C matches one of the pre-programmed reference profiles stored at the controller 1120, the controller 1120 presents the dispensing container attribute data associated with the matching reference profile on the display 1160. That is, the controller 1120 is programmed so as to associate the position of one or more of the potentiometers 970A-C with corresponding dispensing container attributes, including but not limited to: the type of material, the quantity of material, the size of the dispensing container, the date of manufacture, and the like. As such, when the dispensing container 910 is attached to the base, as shown in FIG. 27, and the rotational position of the potentiometers 970A-C matches a reference profile stored at the controller 1120, the controller 1120 supplies dispensing container attribute data associated with the matching reference profile to the display 1160 to be viewed by the user.

Next, as the dispensing nozzle 920 of the dispensing container 910 is depressed downward by a user's hand to actuate the pump 930, the support section 1032 is moved from its normal resting position, shown in FIG. 27, to an actuated position, shown in FIG. 28, so as to actuate the actuation switch 1150. As such, each time the dispensing container 910 is actuated to dispense material therefrom, the support platform 1020 is moved, so as to actuate the actuation switch 1150, which updates the count value stored at the controller 1150. The actuation count value may be presented on the display 1160, and may be used by the controller 1150 to calculate various data including the remaining amount of material, usage rates, and various other data associated with the use of the dispensing container 910 for presentation upon the display 1160. Once the dispensing nozzle 920 is released, the support platform 1020 returns to its normal resting position by operation of springs 1040.

Therefore, one advantage of the present invention is that a proprietary dispensing system utilizes dispensing containers that are configured for use with only compatible bases. Another advantage of the present invention is that the proprietary dispensing system provides a base that counts the number of times a dispensing container has dispensed material. Still another advantage of the present invention is that the proprietary dispensing system provides a base that makes unauthorized dispensing containers unstable when placed therein, preventing its use with the base. Yet another advantage of the present invention is that the proprietary dispensing system provides a system in which unauthorized dispensing containers that utilize a pump that is configured to be actuated in a substantially vertical direction are disabled by the base to which they are attached. Another advantage of the present invention is that the proprietary dispensing system provides a base in which various information associated with the contents of a dispensing container can be acquired and displayed.

Thus, it can be seen that the objects of the invention have been satisfied by the structure and its method for use presented above. While in accordance with the Patent Statutes, only the best mode and preferred embodiment has been presented and described in detail, it is to be understood that the invention is not limited thereto or thereby. Accordingly, for an appreciation of the true scope and breadth of the invention, reference should be made to the following claims.

1. A proprietary dispensing system comprising:
a dispensing container having a dispensing nozzle that when actuated dispenses material therefrom;
a base for carrying said dispensing container;
a support platform carried by said base, said support platform includes a sensing surface that is configured to detect the arrangement of one or more indicators carried by said dispensing container when said dispensing container is placed on said support platform;
a display carried by said base; and
a controller coupled to said display and to said sensing surface, said controller storing dispensing container attribute data that is associated with one or more indicator profiles each defined by a predetermined arrangement of one or more said indicators;
wherein said display presents said stored dispensing container attribute data associated with said indicator profile that matches the arrangement of said one or more indicators detected by said sensing surface carried by said dispensing container.

2. The proprietary dispensing system of claim 1, further comprising:
a switch coupled to said controller, said switch actuated by the movement of said support platform;
wherein said support platform is moveably carried by said base and in operative contact with said switch, such that when said dispensing nozzle of said dispensing container is actuated, said support platform is moved to actuate said switch so as to update a count value stored at said controller for presentation on said display.

3. The proprietary dispensing system of claim 1, wherein said dispensing container includes a base having a plurality of concentric alignment ribs extending therefrom, and wherein said sensing surface is divided by a plurality of concentric base channels, said plurality of base channels arranged to receive at least one of said plurality of said alignment ribs.

4. The proprietary dispensing system of claim 3, wherein said one or more indicators are disposed between said plurality of concentric alignment ribs.

5. The proprietary dispensing system of claim 1, wherein said support platform is biased by at least one spring.

6. The proprietary dispensing system of claim 1, wherein said one or more indicators carried by said dispensing container comprises magnets.

7. A proprietary dispensing system comprising:
a dispensing container having a dispensing nozzle that when actuated dispenses material therefrom, said dispensing container having a base surface with a receiving aperture having one or more indicators disposed therein and arranged in a predetermined pattern;
a base for carrying said dispensing container, said base having a key arm carried by said base, said key arm configured to be received within said receiving aperture, so as to slideably retain said dispensing container to said key arm, said key arm including a sensing surface configured to detect the arrangement of said one or more indicators carried by said dispensing container;
a support platform pivotably carried by said base and having a key aperture through which said key arm passes, said support platform resiliently biased upwardly from said base;
a controller coupled to said sensor, said controller storing dispensing container attribute data that is associated with one or more indicator profiles each defined by a predetermined arrangement of one or more said indicators; and
a display coupled to said controller;
wherein when said receiving aperture of said dispensing container receives said key arm, said base surface of said dispensing container is carried by said support platform, and said display presents said stored dispensing container attribute data associated with said indicator profile that matches the arrangement of said one or more indicators of said dispensing container detected by said sensing surface.

8. The proprietary dispensing system of claim 7, further comprising:
a switch carried by said base and coupled to said controller, said switch configured to be actuated when said platform pivots;
wherein said controller stores a count value, such that when said dispensing nozzle is actuated to dispense material, said support platform pivots to actuate said switch, so as to update said count value at said controller for presentation on said display.

9. The proprietary dispensing system of claim 7, wherein said support platform is biased by a spring.

10. The proprietary dispensing system of claim 7, wherein said indicator comprises magnets.

11. The proprietary dispensing system of claim 7, further comprising a guide wall extending from said base, and partially circumscribing the periphery of said support platform.

12. The proprietary dispensing system of claim 7, wherein said support platform rotates through a platform aperture disposed in said base.

13. A proprietary dispensing system comprising:
a dispensing container having an attachment aperture, said dispensing container having a tube with an inlet to receive liquid material carried by said dispensing container, said tube in fluid communication with said dome pump and a dispensing nozzle, wherein a one-way valve is disposed between said inlet and said dome pump;
a base for carrying said dispensing container, said base having a having a resting section to normally support said base on a surface, said base including a pivot section extending at one end of said resting section upwardly, away from the surface, so as to form a pivot edge;
a wall extending from said pivot section, said wall having a pivot aperture therethrough;
a protrusion extending from said base, said protrusion configured to selectively actuate said dome pump;
an actuation assembly carried by said pivot aperture, said actuation assembly configured to pivot relative to said base, said actuation assembly configured to be lockingly received within said attachment aperture of said dispensing container;
a controller carried by said base, said controller storing a count value;
a switch coupled to said controller, said switch carried by said base so as to be in operative alignment with said dispensing container; and
a display coupled to said controller;
wherein when said dispensing container is pivoted by said actuation assembly so that said dome pump is actuated by said protrusion to dispense material from said dispensing nozzle, said switch is actuated to update said count value, which is presented on said display.

14. The proprietary dispensing system of claim 13, wherein said actuation assembly comprises a pivot sleeve configured to be received within said attachment aperture of said dispensing container, said pivot sleeve being resiliently biased to a support shaft that is configured to be carried by said pivot aperture.

15. The proprietary dispensing system of claim 14, wherein said pivot sleeve is resiliently biased to said support shaft by a spring.

16. A proprietary dispensing system comprising:
a dispensing container having a dispensing nozzle that when actuated dispenses material therefrom, said dispensing container having a base surface, that includes a stop tab and an engagement arm, said engagement arm having one or more control tabs extending therefrom;
a base having a support platform moveably carried by said base, said support platform having a guide slot, and one or more stop slots disposed therethrough, said guide slot configured to receive said engagement arm therethrough, and wherein one of said one or more stop slots are configured to receive said stop tab therein;
at least one potentiometer carried by said base and each said potentiometer configured to be rotated by said control tab;
a controller coupled to each said at least one potentiometer, said controller storing dispensing container attribute data that is associated with one or more reference profiles that are defined by the amount of rotation of each said at least one potentiometer; and
a display coupled to said controller;
wherein when said dispensing container is carried upon said support platform and rotated until said stop tab is stopped by the end one of said one or more stop slots, said one or more control tabs rotate said at least one potentiometer by a predetermined amount, wherein said display presents said stored dispensing container attribute data associated with said reference profile that matches the amount of rotation of each said at least one potentiometer.

17. The proprietary dispensing system of claim 16, wherein said guide slot and said one or more stop slots are arcuate.

18. The proprietary dispensing system of claim 16, wherein said at least one potentiometer comprises a plurality of stacked potentiometers that each have an actuation arm extending therefrom that are configured to operatively contact one or more of said control tabs.

19. The proprietary dispensing system of claim 18, wherein each said actuation arm rotates about a common axis.

20. The proprietary dispensing system of claim 16, further comprising:
a switch coupled to said controller and actuated by the movement of said support platform, such that when said dispensing nozzle of said dispensing container is actuated, said support platform is moved to actuate said switch, so as to update a count value stored at said controller and for presentation on said display.
